(19) United States
(12) Patent Application Publication
(10) Pub. No.: US 2025/0307733 A1
(43) Pub. Date: Oct. 2, 2025

(54) OPERATION PLAN GENERATION DEVICE, OPERATION PLAN GENERATION METHOD, AND COMPUTER-READABLE STORAGE MEDIUM

(71) Applicant: HONDA MOTOR CO.,LTD., Tokyo (JP)

(72) Inventors: Jun YAMAMOTO, Saitama (JP); Kohei TAKIZAWA, Saitama (JP); Minoru MAEDAKO, Saitama (JP); Andrii PYDIN, Saitama (JP)

(21) Appl. No.: 18/619,189

(22) Filed: Mar. 28, 2024

(51) Int. Cl. G06Q 10/0631; G05D 1/224; G05D 1/646; G05D 105/20; G05D 107/90; G06Q 10/083

(52) U.S. Cl. CPC G06Q 10/0631; G05D 1/2246; G05D 1/646; G06Q 10/083; G05D 2105/20; G05D 2107/90

(57) ABSTRACT

Solution: Provided is an operation plan generation device which generates information indicating an operation plan for a working machine which drives using electrical power to perform a predefined work by the working machine.

The operation plan generation device acquires working location information including route information indicating a drivable path set on a map for the working machine in a working location where the working machine engages a work; acquires information indicating a condition regarding power-feeding equipment that can feed electrical power to the working machine installed in the working location; based on the working location information and a plurality of conditions different from each other, each condition being identical to the condition, generates information indicating the operation plan in each of the plurality of conditions.

### BACKGROUND

### 1. Technical Field

The present invention relates to an operation plan generation device, an operation plan generation method, and a computer-readable storage medium.

### 2. Related Art

Patent document 1 describes a technique of creating a plan to load a cargo on a pallet and a plan to load the pallet on a truck. Patent document 2 describes a system for notifying of a schedule according to which a bus arrives at a bus stop. Patent document 3 describes a simulation device for determining which working entity should transport a cargo.

### PRIOR DOCUMENT

### Patent Document

Patent Document 1: Japanese Patent Application Publication No. 2020-15574
Patent Document 2: Japanese Patent Application Publication No. 2002-203299
Patent Document 3: Japanese Patent Application Publication No. 2019-031352

### SUMMARY

In a first aspect of the present invention, an operation plan generation device is provided. The operation plan generation device generates information indicating an operation plan for a working machine which drives using electrical power to perform a predefined work by the working machine. The operation plan generation device includes a first information acquisition unit which acquires working location information including route information indicating a drivable path set on a map for the working machine in a working location where the working machine engages a work. The operation plan generation device includes a second information acquisition unit which acquires information indicating a condition regarding power-feeding equipment that can feed electrical power to the working machine installed in the working location. The operation plan generation device includes an operation plan generation unit which, based on the working location information and a plurality of conditions different from each other, each condition being identical to the condition, generates information indicating the operation plan in each of the plurality of conditions. The operation plan generation device includes an output unit which outputs information indicating the operation plan generated by the operation plan generation unit.

In the operation plan generation device described above, the information indicating the operation plan may include utilization rate information indicating a ratio of a time during which the working machine actually engages the work to an entire work period.

In any of the operation plan generation devices described above, the information indicating the operation plan may include number-of-machine information indicating a number of the working machines required to perform the predefined work.

In any of the operation plan generation devices described above, the plurality of conditions may include a condition regarding a number of pieces of the power-feeding equipment that can feed electrical power to the working machine installed in the working location.

In any of the operation plan generation devices described above, the plurality of conditions may include a condition regarding a location of the power-feeding equipment that can feed electrical power to the working machine installed in the working location.

In any of the operation plan generation devices described above, the output unit may output information indicating the operation plan in each of the plurality of conditions by associating it with the plurality of conditions.

In any of the operation plan generation devices described above, the information indicating the operation plan may include at least one of utilization rate information indicating a ratio of a time during which the working machine actually engages the work to an entire work period, or number-of-machine information indicating a number of the working machines required to perform the predefined work. The output unit may output the at least one of the utilization rate information or the number-of-machine information in each of the plurality of conditions by associating it with the plurality of conditions.

In any of the operation plan generation devices described above, the plurality of conditions may include a condition regarding a number of pieces of the power-feeding equipment that can feed electrical power to the working machine installed in the working location. The output unit may output the information indicating the operation plan in each of the plurality of conditions regarding a number of pieces of the power-feeding equipment by associating it with the plurality of conditions regarding the number of pieces of the power-feeding equipment.

In any of the operation plan generation devices described above, the information indicating the operation plan may include at least one of utilization rate information indicating a ratio of a time during which the working machine actually engages the work to an entire work period, or number-of-machine information indicating a number of the working machines required to perform the predefined work. The output unit may output the at least one of the utilization rate information or the number-of-machine information in each of the plurality of conditions regarding the number of pieces of the power-feeding equipment by associating it with the plurality of conditions regarding the number of pieces of the power-feeding equipment.

In any of the operation plan generation devices described above, the information indicating the operation plan may include information indicating a total drive time during which the working machine drives in order to perform the predefined work.

In any of the operation plan generation devices described above, the second information acquisition unit may further acquire working machine information including an electricity consumption and an battery capacity of the working machine. The operation plan generation unit, based on the working location information, the plurality of conditions different from each other, and the working machine information, may generate information indicating the operation plan in each of the plurality of conditions.

In any of the operation plan generation devices described above, the working machine information may further include a standby power consumption amount, which is a consumed power amount per unit time the working machine consumes on standby.

In any of the operation plan generation devices described above, the information indicating the operation plan may further include total standby power consumption amount information indicating a sum value of standby power consumption amounts the working machine consumes on standby.

In any of the operation plan generation devices described above, the first information acquisition unit may acquire the route information set by a user on the map displayed on a user terminal.

In a second aspect of the present invention, an operation plan generation method is provided. An operation plan generation method is a method for generating information indicating an operation plan for a working machine which drives using electrical power to perform a predefined work by the working machine. The operation plan generation method includes acquiring firstly working location information including route information indicating a drivable path set on a map for the working machine in a working location where the working machine engages a work. The operation plan generation method includes acquiring secondly information indicating a condition regarding power-feeding equipment that can feed electrical power to the working machine installed in the working location. The operation plan generation method includes, based on the working location information and a plurality of conditions different from each other, each condition being identical to the condition, generating information indicating the operation plan in each of the plurality of conditions. The operation plan generation method includes outputting information indicating the operation plan generated by the generating.

In a third aspect of the present invention, a computer-readable storage medium is provided. The computer-readable storage medium is a non-transitory computer-readable storage medium having stored thereon a program. The program is a program for generating information indicating an operation plan for a working machine which drives using electrical power to perform a predefined work by the working machine. The program, when executed by a computer, causes the computer to perform a step of acquiring working location information including route information indicating a drivable path set on a map for the working machine in a working location where the working machine engages a work. The program, when executed by a computer, causes the computer to perform a step of acquiring information indicating a condition regarding power-feeding equipment that can feed electrical power to the working machine installed in the working location. The program, when executed by a computer, causes the computer to perform a step of, based on the working location information and a plurality of conditions different from each other, each condition being identical to the condition, generating information indicating the operation plan in each of the plurality of conditions. The program, when executed by a computer, causes the computer to perform a step of outputting information indicating the operation plan generated by the step of generating information indicating the operation plan.

The summary clause does not describe all necessary features of the present invention. The present invention may also be a sub-combination of the features described above.

### BRIEF DESCRIPTION OF THE DRAWINGS

FIG. 1 represents an overall configuration of a system 10 according to an embodiment.

FIG. 2 schematically represents a functional block configuration of an operation plan generation device 100.

FIG. 3 schematically represents an example of a screen 300 displayed on a display unit included in an output unit 220.

FIG. 4 represents an example of data structure of node information generated by the operation plan generation device 100.

FIG. 5 represents an example of data structure of edge information generated by the operation plan generation device 100.

FIG. 6 represents an example of data structure of working machine information.

FIG. 7 represents an example of data structure of working location condition information.

FIG. 8 represents an example of data structure of job information.

FIG. 9 represents an example of data structure of calculation condition information.

FIG. 10 is an example of a flowchart according to an operation plan generation method performed in the operation plan generation device 100.

FIG. 11 is an example of a flowchart according to a process for generating an operation plan by an operation plan generation unit 204.

FIG. 12 represents an example of information 110 indicating an operation plan output by the operation plan generation unit 204.

FIG. 13 represents another example of information 110 indicating the operation plan output by the operation plan generation unit 204.

FIG. 14 represents an overall configuration of a system 20 according to another embodiment.

FIG. 15 represents an example of a sequence of processes performed by the operation plan generation device 100 and a compute server 130.

FIG. 16 represents an example of a computer 2000.

### DESCRIPTION OF EXEMPLARY EMBODIMENTS

Hereinafter, embodiments of the present invention will be described. However, the following embodiments are not for limiting the invention according to the claims. In addition, not all of the combinations of features described in the embodiments are essential to the solving means of the invention.

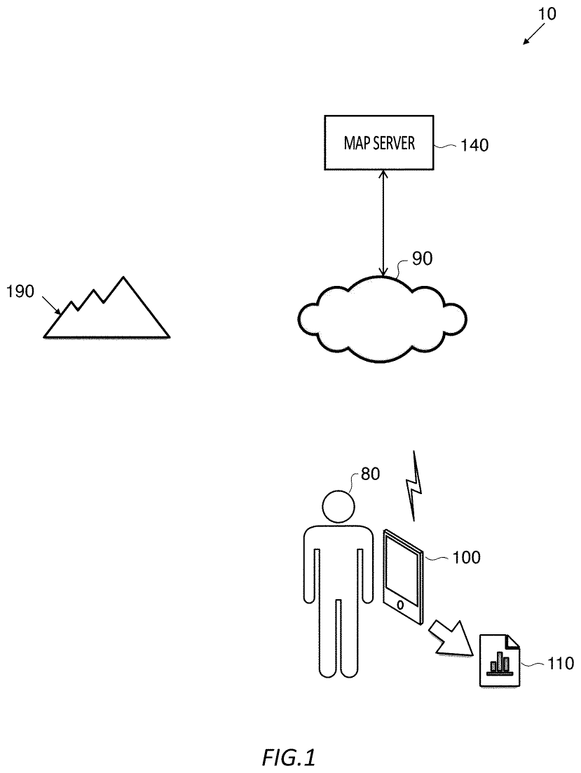

FIG. 1 represents an overall configuration of a system 10 according to an embodiment. The system 10 includes an operation plan generation device 100 and a map server 140.

In the present embodiment, the operation plan generation device 100 generates information indicating an operation plan for a working machine to perform a predefined work. In the present embodiment, the working machine drives using electrical power and performs the work. The working machine includes a battery for storing electrical power for driving. The working machine is, for example, a vehicle for transporting a cargo. The working machine is an unmanned vehicle that performs autonomous driving. The working machine may be operated at a construction site, for example. The working machine, for example, loads a cargo, such as a material to be used at the construction site, at a predefined cargo loading location; drives to a transport destination of the cargo in autonomous driving; unloads the cargo at the transport destination of the cargo; and then drives to the next cargo loading location in autonomous driving.

The operation plan generation device 100 may by electronic equipment. The operation plan generation device 100 may be portable electronic equipment. The operation plan generation device 100 may be a tablet terminal, a smartphone, a cellular phone, a notebook computer, a laptop computer, or the like. The operation plan generation device 100 may be non-portable electronic equipment. The operation plan generation device 100 may be a desktop personal computer or the like. The operation plan generation device 100 may communicate with the map server 140 via a communication network 90 according to a mobile communication standard such as 3G, 4G, 5G, or 6G, the wireless LAN, and/or Wi-Fi (registered trademark).

The operation plan generation device 100 acquires working location information including route information indicating a drivable path set on a map for the working machine in a working location 190 where the working machine engages the work. The operation plan generation device 100 acquires information indicating a condition regarding power-feeding equipment that can feed electrical power to the working machine installed in the working location 190. The power-feeding equipment may be installed to charge the battery included in the working machine.

The power-feeding equipment may be also a portable power supply or a stationary power supply. The power-feeding equipment may include a capacitor as a power supply, or may include a generator as a power supply. The generator may include an internal combustion engine. The generator may generate electricity using fuel. An example of the fuel can include gas such as liquefied petroleum gas and natural gas, fossil fuel or synthetic fuel such as gasoline, kerosene, light oil, and heavy oil, hydrogen or the like. The generator may include a fuel battery.

The operation plan generation device 100, based on the working location information and a plurality of conditions different from each other, generates information indicating an operation plan in each of the plurality of conditions, and outputs information 110 indicating the generated operation plan.

The operation plan generation device 100 acquires a construction plan indicating location information of the working location 190 which is the construction site, a scheduled construction period, the weight and size of cargo transported by the working machine, or the like, from a working entity. The operation plan generation device 100 acquires map data of the working location 190 from the map server 140, and displays a map of the working location 190 on a screen. The map data acquired from the map server 140 may be general-purpose two-dimensional map data. The map data may be generated from a satellite picture. A user 80 specifies a drivable path for the working machine on the screen of the operation plan generation device 100 displaying the map. For example, the operation plan generation device 100 may acquire information indicating the path through a touch operation by the user 80 on the screen displaying the map. The operation plan generation device 100 may acquire information indicating the path through a pointer device such as a mouse or a touch pad operated by the user 80.

The operation plan generation device 100 may acquire the condition regarding power-feeding equipment from an electronic file on which information about the condition regarding the power-feeding equipment is recorded. The condition regarding the power-feeding equipment may be a condition indicating whether there is the power-feeding equipment. The condition regarding the power-feeding equipment may be a condition regarding whether the power-feeding equipment is used. The condition regarding the power-feeding equipment may be a condition regarding a number of pieces of the power-feeding equipment in the working location.

The operation plan generation device 100, based on the working location information and the condition regarding the power-feeding equipment, generates information 110 indicating an operation plan. The operation plan generation device 100 generates, for example, an estimate for a number of the working machines required to transport materials in the construction site (which may be referred to as a “required number”) as the operation plan. For example, the operation plan generation device 100 generates estimate information 110 from which the required number of the working machines when a condition to install the power-feeding equipment is set and the required number of the working machines when a condition not to install the power-feeding equipment (or not to use the power-feeding equipment) is set are to be compared.

For example, it may be required that the working machine performs the work at a relatively large working location 190 relatively away from a point where grid power can be supplied, such as when the working location 190 is a construction site where a solar power plant is to be constructed. Therefore, when the working location 190 is not provided with additional power-feeding equipment, once the remaining charge amount of the battery in the working machine drops, a utilization rate of the working machine may drop because it may be necessary to return to the point where grid power can be supplied (e.g., a base point for the construction such as a point where materials are loaded on the working machine) for charging, or it may be necessary to wait until night time during which charging is performed. In contrast to this, when the working location 190 is provided with additional power-feeding equipment, the working machine is allowed to be charged without returning to the point where grid power can be supplied, thereby the utilization rate of the working machine can be enhanced. According to the operation plan generation device 100, since the estimate information 110 is output for different conditions regarding the power-feeding equipment, information for the construction entity to select whether to install additional power-feeding equipment in the working location 190 can be provided.

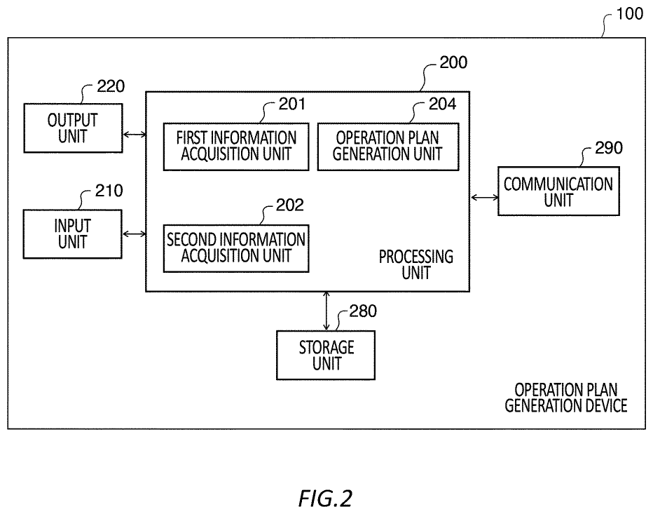

FIG. 2 schematically represents a functional block configuration of the operation plan generation device 100. The operation plan generation device 100 includes a processing unit 200, an input unit 210, an output unit 220, a storage unit 280, and a communication unit 290.

The processing unit 200 is implemented, for example, by an arithmetic processing unit including a processor. The storage unit 280 is implemented to include a non-volatile storage medium. The processing unit 200 performs a process by using information such as a program stored in the storage unit 280. The processing unit 200 or the entire operation plan generation device 100 may be implemented by a computer including a CPU, a ROM, a RAM, an I/O, a bus and the like.

The processing unit 200 includes a first information acquisition unit 201, a second information acquisition unit 202, and an operation plan generation unit 204.

The first information acquisition unit 201 acquires working location information including route information indicating a drivable path set on a map for a working machine in a working location 190 where the working machine engages a work. For example, the first information acquisition unit 201 may acquire the route information set by the user on the map displayed on a user terminal.

The second information acquisition unit 202 acquires information indicating a condition regarding power-feeding equipment that can feed electrical power to the working machine installed in the working location 190. The operation plan generation unit 204, based on the working location information and a plurality of conditions different from each other, generates information indicating an operation plan in each of the plurality of conditions.

The output unit 220 of the operation plan generation device outputs information indicating the operation plan generated by the operation plan generation unit 204. For example, the output unit 220 may output the information indicating the operation plan in each of the plurality of conditions by associating it with the plurality of conditions.

The information indicating the operation plan may include utilization rate information indicating a ratio of a time during which the working machine actually engages the work to an entire work period. The information indicating the operation plan may include number-of-machine information indicating a number of the working machines required to perform the predefined work. The information indicating the operation plan may include information indicating a total drive time during which the working machine drives in order to perform the predefined work.

The plurality of conditions may include a condition regarding a number of pieces of the power-feeding equipment that can feed electrical power to the working machine installed in the working location 190. The plurality of conditions may include a condition regarding a location of the power-feeding equipment that can feed electrical power to the working machine installed in the working location 190.

The information indicating the operation plan may include at least one of the utilization rate information indicating the ratio of the time during which the working machine actually engages the work to the entire work period, or the number-of-machine information indicating the number of the working machines required to perform the predefined work. The output unit 220 may output the at least one of the utilization rate information or the number-of-machine information in each of the plurality of conditions by associating it with the plurality of conditions.

The plurality of conditions may include the condition regarding the number of pieces of the power-feeding equipment that can feed electrical power to the working machine installed in the working location 190. The output unit 220 may output the information indicating the operation plan in each of a plurality of conditions regarding the number of pieces of the power-feeding equipment by associating it with the plurality of conditions regarding the number of pieces of the power-feeding equipment.

The information indicating the operation plan may include at least one of the utilization rate information indicating the ratio of the time during which the working machine actually engages the work to the entire work period, or the number-of-machine information indicating the number of the working machines required to perform the predefined work. The output unit 220 may output the at least one of the utilization rate information or the number-of-machine information in each of the plurality of conditions regarding the number of pieces of the power-feeding equipment by associating it with the plurality of conditions regarding the number of pieces of the power-feeding equipment.

The second information acquisition unit 202 may further acquire working machine information including an electricity consumption and a battery capacity of the working machine. The operation plan generation unit 204, based on the working location information, the plurality of conditions different from each other, and the working machine information, may generate information indicating an operation plan in each of the plurality of conditions.

The working machine information may further include a standby power consumption amount, which is a consumed power amount per unit time the working machine consumes on standby. The information indicating the operation plan may further include total standby power consumption amount information indicating a sum value of standby power consumption amounts the working machine consumes on standby.

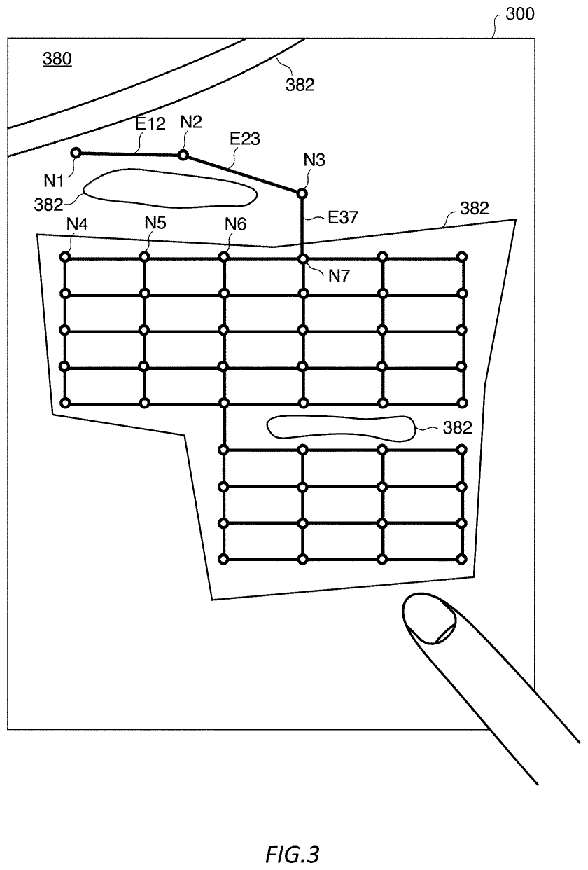

FIG. 3 schematically represents an example of a screen 300 displayed on a display unit included in the output unit 220. On the screen 300, a map 380 including ground feature information 382 indicating a ground feature such as a road, a grassy area, or a pond is displayed based on the map data acquired from the map server 140.

The user 80 specifies locations of a plurality of nodes including a node N1, a node N2, a node N3, a node N4, a node N5, a node N6, and a node N7 on the map 380 through a touch operation on the screen 300 and/or an operation using a pointing device. The nodes represent points at or through which the working machine can stop or pass. The pointing device may include an electronic pen, a mouse, a touch pad, and the like.

The user 80 specifies a plurality of edges including an edge E12, an edge E23, and an edge E37 indicating a drivable path for the working machine on the map 380 through the touch operation on the screen 300. The edges are represented by straight lines connecting between nodes. In FIG. 3, the edges are represented by straight lines. The user 80 specifies an edge by specifying locations of nodes positioned at both ends of the edge on the screen 300.

The operation plan generation device 100 generates node information indicating a coordinate of the node specified by the user 80 and edge information indicating the edge specified by the user 80.

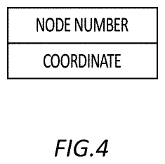

FIG. 4 represents an example of data structure of node information generated by the operation plan generation device 100. The node information associates a node number and a coordinate with each other.

The “node number” is information for identifying a node. The “node number” may be automatically determined in the operation plan generation device 100. The “coordinate” represents a coordinate of a node. The coordinate of the node is determined based on the location on the screen specified by the user 80 as the location of the node. The coordinate of the node may be a value on the actual scale, such as latitude and longitude information. The coordinate of the node may be a value scaled by a particular scaling factor with respect to the actual scale.

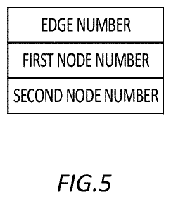

FIG. 5 represents an example of data structure of edge information generated by the operation plan generation device 100. The edge information associates an edge number, a first node number, and a second node number with each other.

The “edge number” is information for identifying an edge. The “edge number” may be automatically determined in the operation plan generation device 100. The “first node number” represents a node number for identifying a node positioned at one end of the edge. The “second node number” represents a node number for identifying a node positioned at the other end of the edge. The first node number and the second node number are determined based on the locations on the screen 300 specified as the nodes positioned at both ends of the edge by the user 80 and the location of each node included in the node information.

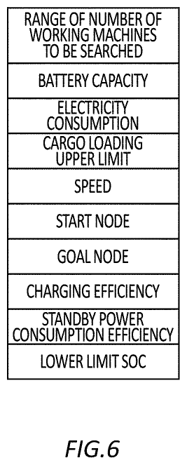

FIG. 6 represents an example of data structure of working machine information. The working machine information associates a range of number of working machines to be searched, a battery capacity, an electricity consumption, a cargo loading upper limit, a speed, a start node, a goal node, a charging efficiency, a standby power consumption efficiency, and a lower limit SOC with each other.

The “range of number of working machines to be searched” specifies a range of the number of working machines that may be targets for calculating the required number of working machines. The operation plan generation unit 204 calculates the required number with the upper limit value of the number of machines in the range of number of working machines to be searched being set as the upper limit.

The “battery capacity” represents a charge capacity of the battery included in the working machine. The “electricity consumption” represents an electricity consumption of the working machine. The electricity consumption represents a power amount consumed when the working machine drives a unit distance. The electricity consumption may be a fixed value. The electricity consumption may be a value determined depending on a weight of a cargo loaded on the working machine.

The “cargo loading upper limit” represents an upper limit of a weight that can be loaded on the working machine. The “speed” represents a speed when the working machine is in steady driving.

The “start node” represents a node number of a node from which the working machine starts moving. The start node may be, for example, a node of a point at which a cargo is loaded. The “goal node” represents a node number of a node to which the working machine returns after transporting the cargo. The goal node may be a node at which the battery of the working machine can be charged.

The “charging efficiency” represents a charging efficiency when the battery of the working machine is charged. The “standby power consumption efficiency” represents a consumed power amount per unit time the working machine consumes on standby.

The “lower limit SOC” represents a lower limit value of the State Of Charge required to allow the working machine to drive. The operation plan generation unit 204 generates an operation plan so as to arrive at the point where the battery of the working machine can be charged before the SOC of the battery reaches the lower limit SOC.

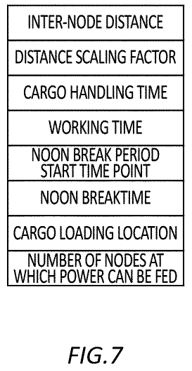

FIG. 7 represents an example of data structure of working location condition information. The working location condition information associates an inter-node distance, a distance scaling factor, a cargo handling time, a working time, a noon break period start time point, a noon breaktime, a cargo loading location, and a number of nodes at which power can be fed.

The “inter-node distance” represents the distance between a pair of nodes. The inter-node distance is calculated based on the node information. The inter-node distance may be a value obtained by scaling a distance in the actual scale by a predefined scaling factor. The “distance scaling factor” represents said defined scaling factor.

The “cargo handling time” represents a time taken to load and unload cargos on/from the working machine. The “working time” represents a time during which works can be performed in one day. The “noon break period start time point” represents a time point at which a noon break starts. The “noon breaktime” represents a time of the noon break. For example, the working time is a time from 8 o'clock to 17 o'clock, the noon break period start time point is 12 o'clock, and the noon breaktime is one hour long.

The “cargo loading location” represents a node number of a node that corresponds to a point where cargos are loaded. The “number of nodes at which power can be fed” represents a number of nodes that correspond to points at which power-feeding equipment is installed in the working location 190. The number of nodes at which power can be fed represents a number of locations where power-feeding equipment is installed in the working location 190, wherein the locations exclude the cargo loading location. That is, the number of nodes at which power can be fed being zero means that the power-feeding equipment for the battery included in the working machine is installed only at the cargo loading location. The number of nodes at which power can be fed is an example of a “condition regarding power-feeding equipment that can feed electrical power” acquired by the second information acquisition unit 202.

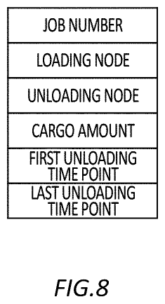

FIG. 8 represents an example of data structure of job information. The job information associates a job number, a loading node, an unloading node, a cargo amount, a first unloading time point, and a last unloading time point with each other.

The “job number” is information for identifying a job. The job represents work content to be performed by the working machine. The job number may be automatically determined in the operation plan generation device 100.

The “loading node” represents a node number of a node that corresponds to a location where cargos are loaded on the working machine. The “unloading node” represents a node number of a node that corresponds to a location where cargos are unloaded from the working machine. The “cargo amount” represents a weight of cargos to be loaded by the working machine.

The “first unloading time point” represents the earliest time point at which the working machine is allowed for unloading. The “last unloading time point” represents the latest time point at which the working machine is allowed for unloading.

The job information is input to the operation plan generation device 100 in the form of an electronic file. The job information may be generated by the user 80 based on a construction plan.

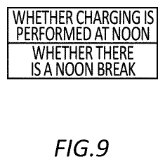

FIG. 9 represents an example of data structure of calculation condition information. The calculation condition information associates whether charging is performed at noon and whether there is a noon break with each other.

“Whether charging is performed at noon” represents whether the working machine performs charging within the working time. If the answer to “whether charging is performed at noon” is yes, it is permitted that charging of the battery in the working machine is performed at the power-feeding equipment within the working time. If the answer to “whether charging is performed at noon” is no, it is not permitted that charging of the battery in the working machine is performed at the power-feeding equipment within the working time. Therefore, if the answer to “whether charging is performed at noon” is no, charging of the battery in the working machine is performed only after the end of the working time. “Whether there is a noon break” represents whether to take a noon break. That is, “whether there is a noon break” represents whether to stop the work by the working machine during the noon breaktime.

The working machine information, the working location condition information, the job information, and the calculation condition information are recorded on the electronic file created by the user 80 based on the construction plan, the node information, and the edge information, and stored in the storage unit 280.

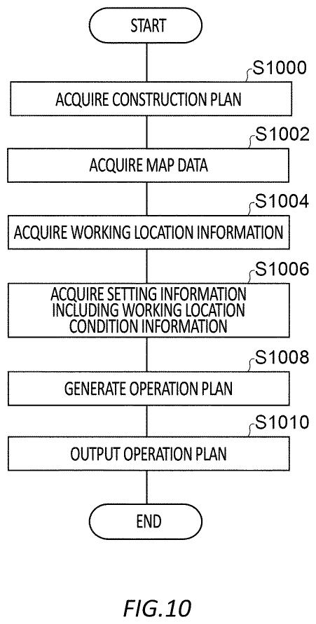

FIG. 10 is an example of a flowchart according to an operation plan generation method performed in the operation plan generation device 100. In S1000, the first information acquisition unit 201 acquires a construction plan. For example, the first information acquisition unit 201 acquires the construction plan by reading an electronic file recorded thereon information indicating the construction plan provided by a construction entity.

In S1002, the first information acquisition unit 201 acquires map data from the map server 140 through the communication unit 290. The first information acquisition unit 201 acquires map data of the working location determined from the construction plan from the map server 140 through the communication unit 290.

In S1004, the first information acquisition unit 201 acquires working location information including route information indicating a drivable path for the working machine in the working location 190. For example, the first information acquisition unit 201 acquires the route information by acquiring information which specifies nodes and edges through the operation of the user 80, as described in connection to FIG. 3 or the like.

In S1006, the second information acquisition unit 202 acquires setting information including working location condition information. The second information acquisition unit 202 acquires the setting information, for example, by reading an electronic file recorded thereon the working machine information, the working location condition information, the job information, and the calculation condition information from the storage unit 280.

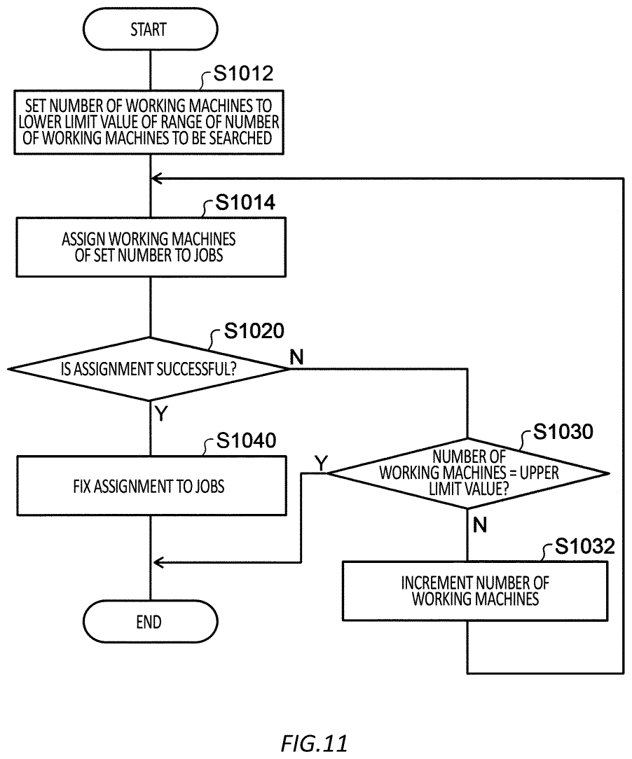

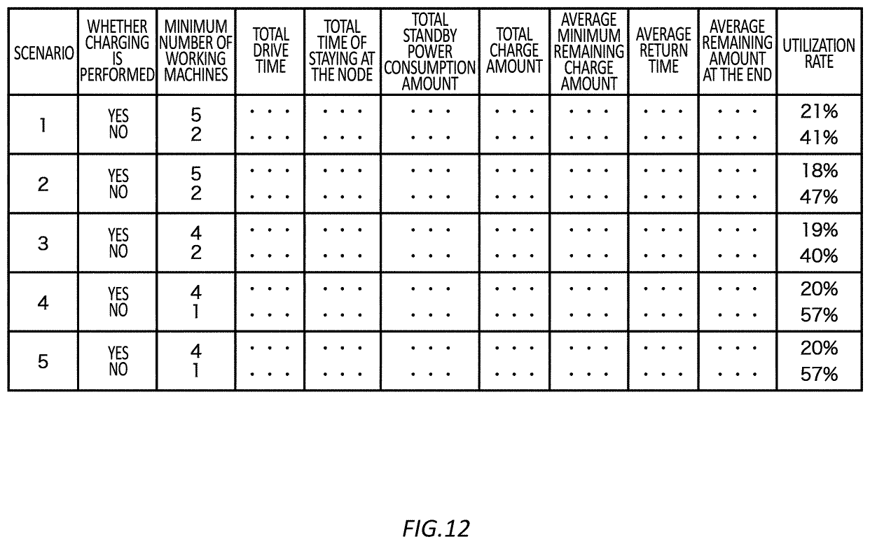

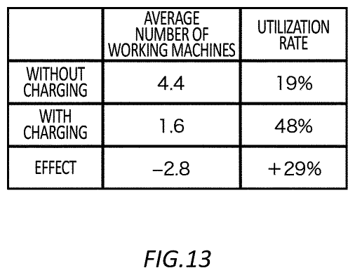

In S1008, the operation plan generation unit 204, based on the working location information and the setting information including the working location condition information, generates information 110 indicating an operation plan in each of a plurality of conditions. A particular example of data item included in the information 110 indicating the operation plan is described in connection to FIG. 12 and FIG. 13. A part of the process in S1008 is described in connection to FIG. 11 or the like.

In S1010, the output unit 220 outputs the information 110 indicating the operation plan generated by the operation plan generation unit 204. For example, the output unit 220 displays the information 110 indicating the operation plan on the display unit. The output unit 220 may output the information 110 indicating the operation plan by printing it. The output unit 220 may output the information 110 indicating the operation plan by recording the information 110 indicating the operation plan on the storage unit 280 or a storage media. The output unit 220 may output the information 110 indicating the operation plan by recording the information 110 indicating the operation plan on a removable storage media. The communication unit 290 may output the information 110 indicating the operation plan by transmitting the information 110 indicating the operation plan to outside through a communication network, and in this case, the communication unit 290 is an example of an output unit which outputs the operation plan.

FIG. 11 is an example of a flowchart according to a process for generating an operation plan by the operation plan generation unit 204. The process of the flowchart in FIG. 11 can be applied as a part of the process in S1008. Especially in FIG. 11, a flow of processes to determine a working machine that executes each job defined by the job information is described.

In S1012, the operation plan generation unit 204 sets a lower limit value of a range of number of working machines to be searched included in the working machine condition information as an initial value of the number of working machines.

In S1014, the operation plan generation unit 204, based on the working machine information, the working location condition information, the job information, and the calculation condition information, performs a process for assigning a working machine among the set number of working machines to each job defined by the job information so as to meet various conditions included in each piece of information.

Here, the operation plan generation unit 204 performs the process in S1014, assuming that power-feeding equipment is installed at nodes of a number indicated by the “number of nodes at which power can be fed” in the working location condition information, in addition to the node that corresponds to the predefined cargo loading location. For the plurality of nodes, an order of priority in which the nodes are selected as the nodes where power-feeding equipment is to be installed may be set in advance, and the operation plan generation unit 204, according to the order of priority, may select nodes of a number indicated by the “number of nodes at which power can be fed” among the plurality of nodes as the nodes where power-feeding equipment is to be installed. The operation plan generation unit 204 may determine a period during which the working machine stops at each node based on the job information, and based on the period during which the working machine stops at each node, nodes of a number indicated by the “number of nodes at which power can be fed” among the plurality of nodes may be selected as the nodes where power-feeding equipment is installed. The operation plan generation unit 204, based on the period during which the working machine stops at each node, may preferentially select nodes where the working machine stops for a longer period among the plurality of nodes, as the nodes where power-feeding equipment is installed. The operation plan generation unit 204 may determine a number of times the working machine stops at each node based on the job information, and based on the number of times the working machine stops at each node, nodes of a number indicated by the “number of nodes at which power can be fed” among the plurality of nodes may be selected as the nodes where power-feeding equipment is installed. The operation plan generation unit 204, based on the number of times the working machine stops at each node, may preferentially select nodes where the working machine stops more frequently among the plurality of nodes, as the nodes where power-feeding equipment is installed.

In S1020, the operation plan generation unit 204 determines whether the process for assigning the working machine to the job is successful. If it is determined that the process for assigning the working machine to the job fails in S1020, in S1030, the operation plan generation unit 204 determines whether the number of working machines currently set is the upper limit value in the range of number of working machines to be searched.

If it is determined that the number of working machines currently set is not the upper limit value in the range of number of working machines to be searched in S1030, in S1032, the operation plan generation unit 204 increments the number of working machines by one, and proceeds the process to S1014.

If it is determined that the process for assigning the working machine to the job is successful in S1020, in S1040, the operation plan generation unit 204 fixes the assignment of the working machine to each job in S1014. Thereby, the working machine that executes each job defined by the job information is determined. In S1008 in FIG. 10, the operation plan generation unit 204 generates the information 110 indicating the operation plan based on the fixed assignment of the working machine to each job.

If it is determined that the number of working machines currently set is the upper limit value in the range of number of working machines to be searched in S1030, then the process of the present flowchart ends. This means that the number of working machines within the range of number of working machines to be searched is not enough to execute the jobs.

The processes described in connection to FIG. 11 may be performed in each of a plurality of conditions with at least the number of nodes at which power can be fed in the working location condition information being set to different values. Thereby, information indicating an operation plan in each of the plurality of conditions different from each other can be generated.

FIG. 12 represents an example of information 110 indicating an operation plan output by the operation plan generation unit 204. The information 110 indicating the operation plan is information for associating a scenario, whether charging is performed, a minimum number of working machines, a total drive time, a total time of staying at the node, a total standby power consumption amount, a total charge amount, an average minimum remaining charge amount, an average return time, an average remaining amount at the end, and a utilization rate with each other. The information 110 indicating the operation plan may be output, for example, in a tabular format.

The “scenario” is information for identifying a scenario. For example, the scenario is set depending on conditions included in the working location information and the calculation condition information. For example, a plurality of scenarios can be set by changing the cargo loading location in the working location condition information, changing whether there is a noon break, or the like.

“Whether charging is performed” represents whether power-feeding equipment is installed in the working location 190. If the number of nodes at which power can be fed is one or more, then the answer to “whether charging is performed” is “yes”, or if the number of nodes at which power can be fed is zero, then the answer to “whether charging is performed” is “no”.

The “minimum number of working machines” represents a number of working machines that can execute each job defined by the job information. The minimum number of working machines is, for example, a number of working machines that were successfully assigned to each job fixed in S1040. The minimum number of working machines is an example of number-of-machine information indicating a number of working machines required to perform a predefined work. Generally, if the answer to “whether charging is performed” is “yes”, then the minimum number of working machines may be lower than if the answer to “whether charging is performed” is “no”.

The “total drive time” is a sum value of times during which all working machines drive in order to execute each job defined by the job information. The total drive time is an example of information indicating a total drive time during which a working machine drives in order to perform a predefined work.

The “total time of staying at the node” is a sum value of times during which all working machines stay at a point corresponding to a node. Generally, if the answer to “whether charging is performed” is “yes”, then the time of charging at the node where additional power-feeding equipment is installed may be longer, so the total time of staying at the node may be longer than if the answer to “whether charging is performed” is “no”.

The “total standby power consumption amount” is a sum value of standby power consumption amounts by all working machines. Generally, if the answer to “whether charging is performed” is “yes”, then the total standby power consumption amount may be lower than if the answer to “whether charging is performed” is “no”. This is because the battery in the working machine may be charged at the power-feeding equipment if the answer to “whether charging is performed” is “yes”, thus a lot of jobs can be executed in one day, and in turn, the time during which the working machine is on standby may be shorter.

The “total charge amount” is a sum value of power amounts required to charge all working machines at the additional power-feeding equipment installed in the working location 190. Generally, if the answer to “whether charging is performed” is “yes”, then the total charge amount may be greater than if the answer to “whether charging is performed” is “no”.

The “average minimum remaining charge amount” is an average value of minimum values of the remaining capacities of the batteries in the working machines. Generally, if the answer to “whether charging is performed” is “yes”, since the batteries in the working machines will be charged at the power-feeding equipment, the average minimum remaining charge amount may be greater than if the answer to “whether charging is performed” is “no”.

The “average return time” is an average value of times from when the working machines depart from a location corresponding to the start node to when they arrive at a location corresponding to the goal node. Generally, if the answer to “whether charging is performed” is “yes”, since the batteries in the working machines will be charged at the power-feeding equipment, the average return time may be longer than if the answer to “whether charging is performed” is “no”.

The “average remaining charge amount at the end” is an average value of remaining capacities of the batteries in the working machines at the end of the work. Generally, if the answer to “whether charging is performed” is “yes”, since the batteries in the working machines may be charged at the power-feeding equipment, the average remaining charge amount at the end may be greater than if the answer to “whether charging is performed” is “no”.

The “utilization rate” represents a ratio of a time during which the working machine engages the work to an entire work period. The entire work period is, for example, a time obtained by multiplying the working time in one day by a number of days of the scheduled construction period. The time during which the working machine engages the work is a sum value of a time during which the working machine drives in order to transport cargos, a time during which cargos are loaded, and a time during which cargos are unloaded. That is, a time during which the working machine is on standby and a time of charging the battery are not included in the time during which the working machine engages the work. The utilization rate is an example of a utilization rate information indicating a ratio of a time during which the working machine actually engages the work to an entire work period. Generally, if the answer to “whether charging is performed” is “yes”, then the utilization rate may be higher than if the answer to “whether charging is performed” is “no”.

In this manner, according to the operation plan generation device 100, having being associated with when the answer to the “whether charging is performed” is “yes” and when the answer to the “whether charging is performed” is “no”, respectively, the minimum number of working machines, the total drive time, the total time of staying at the node, the total standby power consumption amount, the total charge amount, the average minimum remaining charge amount, the average return time, the average remaining amount at the end, and the utilization rate can be output as the information 110 indicating the operation plan. Therefore, information 110 from which when the power-feeding equipment is installed in the working location 190 and when the power-feeding equipment is not installed in the working location 190 are compared can be presented.

In FIG. 12, although the embodiment is described in which the minimum number of working machines, the total drive time, the total time of staying at the node, the total standby power consumption amount, the total charge amount, the average minimum remaining charge amount, the average return time, the average remaining amount at the end, and the utilization rate are output by associating them with “whether charging is performed”, the number of nodes at which power can be fed may also be applied instead of “whether charging is performed”.

FIG. 13 represents another example of information 110 indicating the operation plan output by the operation plan generation unit 204. In this example, the information 110 indicating the operation plan includes information indicating the average number of working machines and the utilization rate in each of when the charging equipment is installed in the working location 190 and when the charging equipment is not installed in the working location 190, and information indicating an effect of installing the charging equipment in the working location 190.

The “average number of working machines” corresponding to “without charging” represents a value obtained by averaging minimum numbers of working machines when the answer to “whether charging is performed” is “no” over a plurality of scenarios. The “average number of working machines” corresponding to “with charging” represents a value obtained by averaging minimum numbers of working machines when the answer to “whether charging is performed” is “yes” over the plurality of scenarios.

The “utilization rate” corresponding to “without charging” represents a value obtained by averaging utilization rates when the answer to “whether charging is performed” is “no” over the plurality of scenarios. The “utilization rate” corresponding to “with charging” represents a value obtained by averaging utilization rates when the answer to “whether charging is performed” is “yes” over the plurality of scenarios.

The “average number of working machines” in information of the “effect” represents a value obtained by subtracting the average number of working machines corresponding to “without charging” from the average number of working machines corresponding to “with charging”. The “utilization rate” in information of the “effect” represents a value obtained by subtracting the utilization rate corresponding to “without charging” from the utilization rate corresponding to “with charging”.

As illustrated in FIG. 13, according to the operation plan generation device 100, how much the required number of the working machine can be reduced and how much the utilization rate can be increased by installing the charging equipment in the working location 190 compared to when not installing the charging equipment in the working location 190, can be presented.

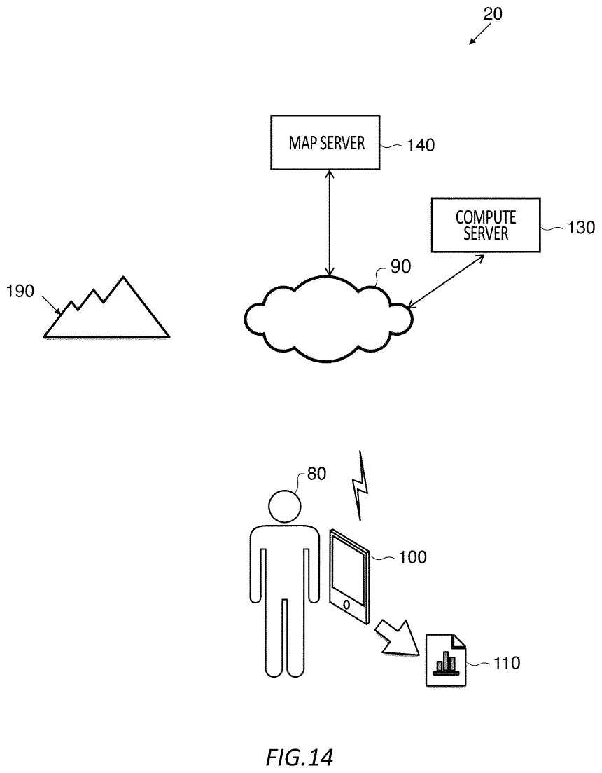

FIG. 14 represents an overall configuration of a system 20 according to another embodiment. The system 20 includes the operation plan generation device 100, the map server 140, and a compute server 130. The system 20 differs from the system 10 in that the system 20 includes the compute server 130. Here, differences between the system 20 and the system 10 will be mainly described. In the system 20, the compute server 130 is mainly responsible for the processes described in connection to FIG. 11.

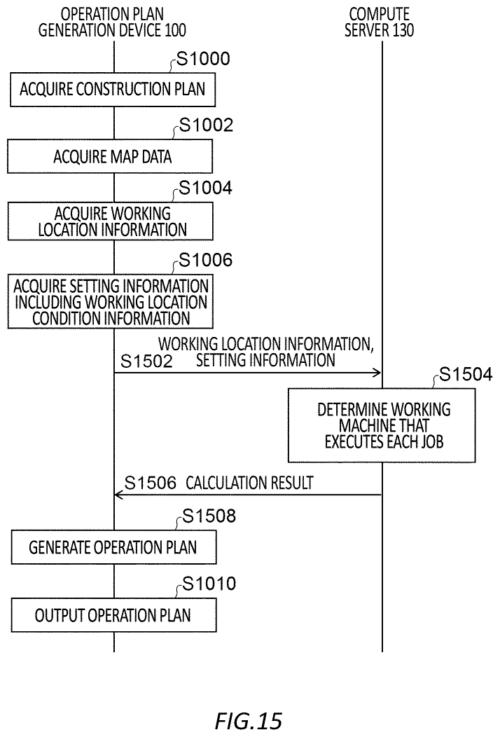

FIG. 15 represents an example of a sequence of processes performed by the operation plan generation device 100 and the compute server 130. In the sequence illustrated in FIG. 15, the processes of S1000, S1002, S1004, S1006, and S1010 are the same as the processes of S1000, S1002, S1004, S1006, and S1010 in FIG. 10, respectively, so the description thereof is omitted.

In S1502, the operation plan generation device 100 transmits the working location information and the setting information to the compute server 130. The compute server 130, based on the working location information and the setting information received from the operation plan generation device 100, performs a calculation for determining a working machine that executes each job. Specifically, the computer server 130 performs the processes describe in connection to FIG. 11.

In S1506, the compute server 130 transmits information indicating a calculation result in S1504 to the operation plan generation device 100. In S1508, the operation plan generation unit 204, based on the information indicating the calculation result received from the compute server 130, generates information indicating an operation plan. For example, the operation plan generation unit 204 generates the information illustrated in FIG. 12, FIG. 13, and the like.

According to the system 20, at least a part of the process for generating the operation plan can be performed at the compute server 130. Thereby, at least a part of the process for generating the operation plan can be provided in the form of the Software as a Service (Saas).

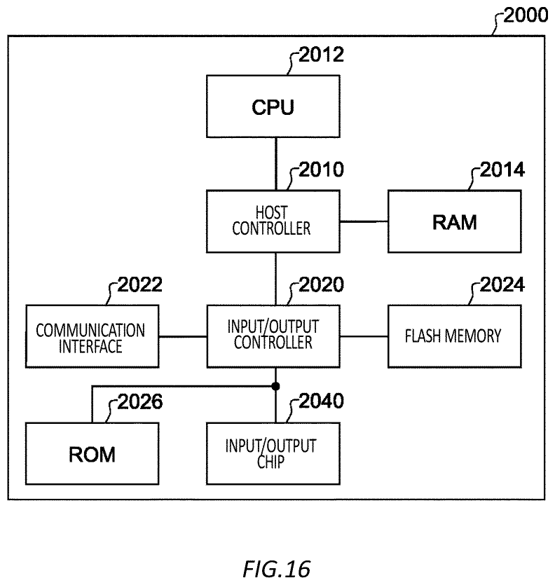

FIG. 16 represents an example of a computer 2000 in which a plurality of embodiments of the present invention can be entirely or partially embodied. A program installed into the computer 2000 can cause the computer 2000 to function as a server or each unit of a system, or a device such as various input devices or each unit of the device according to an embodiment; to perform an operation associated with the system or each unit of the system, or the device or each unit of the device; and/or to perform a process or a step of the process according to an embodiment. Such a program may be executed by a CPU 2012 in order to cause the computer 2000 to execute a specific operation associated with some or all of the processing procedures and the blocks in the block diagrams described herein.

The computer 2000 according to the present embodiment includes the CPU 2012 and a RAM 2014, which are mutually connected by a host controller 2010. The computer 2000 also includes a ROM 2026, a flash memory 2024, a communication interface 2022, and an input/output chip 2040. The ROM 2026, the flash memory 2024, the communication interface 2022, and the input/output chip 2040 are connected to the host controller 2010 via an input/output controller 2020.

The CPU 2012 operates according to programs stored in the ROM 2026 and the RAM 2014, and thereby controls each unit.

The communication interface 2022 communicates with another electronic device via a network. The flash memory 2024 stores a program and data used by the CPU 2012 in the computer 2000. The ROM 2026 stores a boot program or the like executed by the computer 2000 during activation, and/or a program depending on hardware of the computer 2000. The input/output chip 2040 may also connect various input/output units such as a keyboard, a mouse, and a monitor, to the input/output controller 2020 via input/output ports such as a serial port, a parallel port, a keyboard port, a mouse port, a monitor port, a USB port, an HDMI (registered trademark) port.

A program is provided via a computer-readable storage medium such as a CD-ROM, a DVD-ROM, or a memory card, or a network. The RAM 2014, the ROM 2026, or the flash memory 2024 is an example of the computer-readable storage medium. The program is installed in the flash memory 2024, the RAM 2014, or the ROM 2026, and executed by the CPU 2012. Information processing written in these programs is read by the computer 2000, and provides cooperation between the program and the various types of hardware resources described above. A device or a method may be configured by implementing operations or processes of information depending on a use of the computer 2000.

For example, when a communication is executed between the computer 2000 and an external device, the CPU 2012 may execute a communication program loaded in the RAM 2014, and instruct the communication interface 2022 to execute a communication process based on a process written in the communication program. Under the control of the CPU 2012, the communication interface 2022 reads transmission data stored in a transmission buffer processing region provided in a recording medium such as the RAM 2014 or the flash memory 2024, transmits the read transmission data to the network, and writes reception data received from the network into a reception buffer processing region or the like provided on the recording medium.

In addition, the CPU 2012 may cause all or a necessary portion of a file or a database stored in a recording medium such as the flash memory 2024 to be read into the RAM 2014, and execute various kinds of processes on the data on the RAM 2014. Next, the CPU 2012 writes back the processed data into the recording medium.

Various types of information such as various types of programs, data, a table, and a database may be stored in the recording medium and may be subjected to information processing. The CPU 2012 may execute, on the data read from the RAM 2014, various kinds of processes including various kinds of operations, information processing, conditional judgement, conditional branching, unconditional branching, information retrieval/replacement, or the like described herein and specified by instruction sequences of the programs, and write back a result into the RAM 2014. In addition, the CPU 2012 may retrieve information in a file, a database, or the like in the recording medium. For example, when multiple entries each having an attribute value of a first attribute associated with an attribute value of a second attribute, are stored in the recording medium, the CPU 2012 may retrieve an entry having a designated attribute value of the first attribute that matches a condition from these multiple entries, and read the attribute value of the second attribute stored in this entry, thereby obtaining the attribute value of the second attribute associated with the first attribute that satisfies a predefined condition.

The programs or software modules described above may be stored in the computer-readable storage medium on the computer 2000 or in the vicinity of the computer 2000. A recording medium such as a hard disk or a RAM provided in a server system connected to a dedicated communication network or the Internet can be used as the computer-readable storage medium. A program stored in the computer-readable storage medium may be provided to the computer 2000 via a network.

Programs that are installed into the computer 2000 and that cause the computer 2000 to function as the operation plan generation device 100 may act on the CPU 2012 or the like and cause the computer 2000 to function as each unit of the operation plan generation device 100, respectively. Information processing written in these program functions as each unit of the operation plan generation device 100, which is a specific means obtained by cooperating software and various hardware resources described above, by being read into the computer 2000. And, a specific operation plan generation device 100 depending on an intended use is constructed by implementing operations or processing of information depending on the intended use of the computer 2000 in the present embodiment by these specific means,

Programs that are installed into the computer 2000 and that cause the computer 2000 to function as the compute server 130 may act on the CPU 2012 or the like and cause the computer 2000 to function as each unit of the compute server 130, respectively. Information processing written in these programs functions as each unit of the compute server 130, which is a specific means obtained by cooperating software and various hardware resources described above, by being read into the computer 2000. And, a specific compute server 130 depending on an intended use is constructed by implementing operations or processing of information depending on the intended use of the computer 2000 in the present embodiment by these specific means,

Various embodiments have been described with reference to the block diagrams and the like. In the block diagrams, each block may represent (1) a step of a process in which an operation is executed, or (2) each unit of the device having a role in executing the operation. A specific step and each unit may be implemented by a dedicated circuit, a programmable circuit supplied with computer-readable instructions stored on a computer-readable storage medium, and/or a processor supplied with computer-readable instructions stored on a computer-readable storage medium. The dedicated circuit may include a digital and/or analog hardware circuit, or may include an integrated circuit (IC) and/or a discrete circuit. The programmable circuit may include a reconfigurable hardware circuit including logical AND, logical OR, logical XOR, logical NAND, logical NOR, and another logical operation, and a memory element such as a flip-flop, a register, a field programmable gate array (FPGA), a programmable logic array (PLA), or the like.

The computer-readable storage medium may include any tangible device capable of storing instructions to be executed by an appropriate device. Thereby, the computer-readable storage medium having instructions stored therein forms at least a part of a product including instructions which can be executed to provide means for executing operations specified in the processing procedures or the block diagrams. Examples of the computer-readable storage medium may include an electronic storage medium, a magnetic storage medium, an optical storage medium, an electromagnetic storage medium, a semiconductor storage medium, and the like. More specific examples of the computer-readable storage medium may include a floppy (registered trademark) disk, a diskette, a hard disk, a random access memory (RAM), a read only memory (ROM), an erasable programmable read only memory (EPROM or flash memory), an electrically erasable programmable read only memory (EEPROM), a static random access memory (SRAM), a compact disk read only memory (CD-ROM), a digital versatile disc (DVD), a Blu-ray (registered trademark) disc, a memory stick, an integrated circuit card, or the like.

The computer-readable instructions may include an assembler instruction, an instruction-set-architecture (ISA) instruction, a machine instruction, a machine dependent instruction, a microcode, a firmware instruction, state-setting data, or either of source code or object code written in any combination of one or more programming languages including an object oriented programming language such as Smalltalk (registered trademark), JAVA (registered trademark), and C++, and a conventional procedural programming language such as a “C” programming language or a similar programming language.

Computer-readable instructions may be provided to a processor of a general purpose computer, a special purpose computer, or another programmable data processing device, or to programmable circuit, locally or via a local area network (LAN), wide area network (WAN) such as the Internet, and a computer-readable instruction may be executed to provide means for executing operations specified in the described processing procedures or block diagrams. Examples of the processor include a computer processor, a processing unit, a microprocessor, a digital signal processor, a controller, a microcontroller, and the like.

While the present invention has been described by way of the embodiments, the technical scope of the present invention is not limited to the above-described embodiments. It is apparent to persons skilled in the art that various alterations or improvements can be made to the above-described embodiments. It is also apparent from description of the claims that the embodiments to which such alterations or improvements are made can be included in the technical scope of the present invention.

The operations, procedures, steps, and stages etc. of each process performed by a device, system, program, and method shown in the claims, specification, or drawings can be executed in any order as long as the order is not indicated by “before”, “prior to”, or the like and as long as the output from a previous process is not used in a later process. Even if the operation flow is described using phrases such as “first” or “next” for the sake of convenience in the claims, specification, or drawings, it does not necessarily mean that the process must be performed in this order.

### EXPLANATION OF REFERENCES

80: user;
10, 20: system;
90: communication network;
100: operation plan generation device;
110: information;
130: compute server;
140: map server
190: working location;
201: first information acquisition unit;
202: second information acquisition unit;
204: operation plan generation unit;
300: screen;
382: ground feature information;
200: processing unit;
210: input unit;
220: output unit;
280: storage unit;
290: communication unit;
2000: computer;
2010: host controller;
2012: CPU;
2014: RAM;
2020: input/output controller;
2022: communication interface;
2024: flash memory;
2026: ROM;
2040: input/output chip.

What is claimed is:

1. An operation plan generation device which generates information indicating an operation plan for a working machine which drives using electrical power to perform a predefined work by the working machine, the operation plan generation device comprising:
a first information acquisition unit which acquires working location information including route information indicating a drivable path set on a map for the working machine in a working location where the working machine engages a work;
a second information acquisition unit which acquires information indicating a condition regarding power-feeding equipment that can feed electrical power to the working machine installed in the working location;
an operation plan generation unit which, based on the working location information and a plurality of conditions different from each other, each condition being identical to the condition, generates information indicating the operation plan in each of the plurality of conditions; and
an output unit which outputs information indicating the operation plan generated by the operation plan generation unit.

2. The operation plan generation device according to claim 1, wherein
the information indicating the operation plan includes utilization rate information indicating a ratio of a time during which the working machine actually engages the work to an entire work period.

3. The operation plan generation device according to claim 1, wherein
the information indicating the operation plan includes number-of-machine information indicating a number of the working machines required to perform the predefined work.

4. The operation plan generation device according to claim 2, wherein
the information indicating the operation plan further includes number-of-machine information indicating a number of the working machines required to perform the predefined work.

5. The operation plan generation device according to claim 1, wherein
the plurality of conditions include a condition regarding a number of pieces of the power-feeding equipment that can feed electrical power to the working machine installed in the working location.

6. The operation plan generation device according to claim 2, wherein
the plurality of conditions include a condition regarding a number of pieces of the power-feeding equipment that can feed electrical power to the working machine installed in the working location.

7. The operation plan generation device according to claim 3, wherein
the plurality of conditions include a condition regarding a number of pieces of the power-feeding equipment that can feed electrical power to the working machine installed in the working location.

8. The operation plan generation device according to claim 1, wherein
the plurality of conditions include a condition regarding a location of the power-feeding equipment that can feed electrical power to the working machine installed in the working location.

9. The operation plan generation device according to claim 1, wherein
the output unit outputs information indicating the operation plan in each of the plurality of conditions by associating it with the plurality of conditions.

10. The operation plan generation device according to claim 9, wherein
the information indicating the operation plan includes at least one of utilization rate information indicating a ratio of a time during which the working machine actually engages the work to an entire work period, or number-of-machine information indicating a number of the working machines required to perform the predefined work, and
the output unit outputs the at least one of the utilization rate information or the number-of-machine information in each of the plurality of conditions by associating it with the plurality of conditions.

11. The operation plan generation device according to claim 9, wherein
the plurality of conditions include a condition regarding a number of pieces of the power-feeding equipment that can feed electrical power to the working machine installed in the working location, and
the output unit outputs the information indicating the operation plan in each of the plurality of conditions regarding a number of pieces of the power-feeding equipment by associating it with the plurality of conditions regarding the number of pieces of the power-feeding equipment.

12. The operation plan generation device according to claim 11, wherein
the information indicating the operation plan includes at least one of utilization rate information indicating a ratio of a time during which the working machine actually engages the work to an entire work period, or number-of-machine information indicating a number of the working machines required to perform the predefined work, and
the output unit outputs the at least one of the utilization rate information or the number-of-machine information in each of the plurality of conditions regarding the number of pieces of the power-feeding equipment by associating it with the plurality of conditions regarding the number of pieces of the power-feeding equipment.

13. The operation plan generation device according to claim 1, wherein
the information indicating the operation plan includes information indicating a total drive time during which the working machine drives in order to perform the predefined work.

14. The operation plan generation device according to claim 2, wherein
the information indicating the operation plan includes information indicating a total drive time during which the working machine drives in order to perform the predefined work.

15. The operation plan generation device according to claim 1, wherein
the second information acquisition unit further acquires working machine information including an electricity consumption and an battery capacity of the working machine, and
the operation plan generation unit, based on the working location information, the plurality of conditions different from each other, and the working machine information, generates information indicating the operation plan in each of the plurality of conditions.

16. The operation plan generation device according to claim 15, wherein
the working machine information further includes a standby power consumption amount, which is a consumed power amount per unit time the working machine consumes on standby.

17. The operation plan generation device according to claim 16, wherein
the information indicating the operation plan further includes total standby power consumption amount information indicating a sum value of standby power consumption amounts the working machine consumes on standby.

18. The operation plan generation device according to claim 1, wherein
the first information acquisition unit acquires the route information set by a user on the map displayed on a user terminal.

19. An operation plan generation method for generating information indicating an operation plan for a working machine which drives using electrical power to perform a predefined work by the working machine, the operation plan generation method comprising:
acquiring firstly working location information including route information indicating a drivable path set on a map for the working machine in a working location where the working machine engages a work;
acquiring secondly information indicating a condition regarding power-feeding equipment that can feed electrical power to the working machine installed in the working location;
based on the working location information and a plurality of conditions different from each other, each condition being identical to the condition, generating information indicating the operation plan in each of the plurality of conditions; and
outputting information indicating the operation plan generated by the generating.

20. A non-transitory computer-readable storage medium having stored thereon a program, the program being for generating information indicating an operation plan for a working machine which drives using electrical power to perform a predefined work by the working machine, wherein the program, when executed by a computer, causes the computer to perform operations comprising:
acquiring working location information including route information indicating a drivable path set on a map for the working machine in a working location where the working machine engages a work;
acquiring information indicating a condition regarding power-feeding equipment that can feed electrical power to the working machine installed in the working location;
based on the working location information and a plurality of conditions different from each other, each condition being identical to the condition, generating information indicating the operation plan in each of the plurality of conditions; and
outputting information indicating the operation plan generated by the generating information indicating the operation plan.
